(19) United States
(12) Patent Application Publication
(10) Pub. No.: US 2022/0104304 A1
(43) Pub. Date: Mar. 31, 2022

(54) DYNAMIC CONNECTION INTERVAL BASED ON ENVIRONMENTAL CONDITIONS

(71) Applicant: Apple Inc., Cupertino, CA (US)

(72) Inventors: Yann LY-GAGNON, San Francisco, CA (US); Arun UNKN, Cupertino, CA (US)

(73) Assignee: Apple Inc., Cupertino, CA (US)

(21) Appl. No.: 17/032,641

(22) Filed: Sep. 25, 2020

(51) Int. Cl. H04W 76/20; H04W 76/15; H04W 4/80; H04W 84/12; H04L 12/26

(52) U.S. Cl. CPC H04W 76/20; H04W 76/15; H04L 43/0817; H04W 84/12; H04L 43/0811; H04W 4/80

(57) ABSTRACT

Some aspects of this disclosure include apparatuses and methods for dynamically determining or adjusting connection parameters of multiple connections. Some aspects relate to an electronic device. The electronic device includes a transceiver configured to communicate based on a short range communication protocol and a processor communicatively coupled to the transceiver. The processor is configured to measure one or more metrics. The processor is further configured to determine, using the one or more metrics, a first connection parameter associated with a first connection to a first electronic device. The processor is further configured to determine, using the one or more metrics, a second connection parameter associated with a second connection to a second electronic device. The processor is further configured to operate the first connection based on the first connection parameter and the second connection based on the second connection parameter.

### BACKGROUND

### Field

This disclosure generally relates to techniques for dynamically determining connection parameters of multiple connections.

### Related Art

A first electronic device can be connected to a plurality of electronic devices using its Bluetooth™ transceiver. The plurality of electronic devices can be connected to the first electronic device using their respective Bluetooth™ connection. Each of the plurality of the connections can have its respective connection requirements such as bandwidth, power, latency, etc. The plurality of electronic devices will compete for connection time with the first electronic device. Additionally, the plurality of electronic devices will compete for the first electronic device's power to support their respective connection.

### SUMMARY

Some aspects of this disclosure include apparatuses and methods for dynamically determining or adjusting connection parameters of multiple connections. For example, some aspects of this disclosure include apparatuses and methods for dynamically determining or adjusting connection parameters of multiple Bluetooth™ connections between a first electronic device and a plurality of electronic devices. It is noted that although some examples of this disclosure are discussed with respect to a Bluetooth™ protocol, a Bluetooth™ Low Energy protocol, or a Bluetooth™ Low Energy Long Range protocol, the aspects of this disclosure can be applied to any short range communication protocol and/or other communication protocols.

By dynamically determining the connection parameters (such as, but not limited to, connection intervals) of multiple connections (e.g., short range communication protocol such as, but not limited to, Bluetooth™), resources (such as, but not limited to, connection time, power, etc.) can be shared efficiently and effectively between multiple devices. Additionally, or alternatively, user experiences can be improved by dynamically determining the connection parameters based on, for example, connection requirements and/or priorities of the connections.

Some aspects relate to an electronic device. The electronic device includes a transceiver configured to communicate based on a short range communication protocol and a processor communicatively coupled to the transceiver. The processor is configured to measure one or more metrics. The processor is further configured to determine, using the one or more metrics, a first connection parameter associated with a first connection to a first electronic device. The processor is further configured to determine, using the one or more metrics, a second connection parameter associated with a second connection to a second electronic device. The processor is further configured to operate the first connection based on the first connection parameter and the second connection based on the second connection parameter.

In some examples, the first connection parameter includes a first connection interval associated with the first connection and the second connection parameter includes a second connection interval associated with the second connection.

In some examples, to determine the first connection parameter the processor is configured to determine a first priority associated with the first connection and to determine the second connection parameter the processor is configured to determine a second priority associated with the second connection.

In some examples, the one or more metrics includes at least one of a Received Signal Strength Indicator (RSSI) value, an Angle of Arrival (AOA) value, a motion parameter, or a battery level.

In some examples, the processor is further configured to determine whether an adjusting condition has occurred and in response to determining that the adjusting condition has occurred, adjust at least one of the first connection parameter or the second connection parameter.

In some examples, the adjusting condition includes at least one of a predetermined time period, the electronic device establishing a third connection with a third electronic device, or the electronic device dropping the second connection with the second electronic device.

In some examples, the one or more metrics includes a Received Signal Strength Indicator (RSSI) value and an Angle of Arrival (AOA) value and the first connection parameter includes a first connection interval. To adjust the first connection parameter, the processor is configured to compare the RSSI value with a threshold. In response to the RSSI value being less than the threshold, the processor is configured to determine whether the electronic device is static and determine whether the AOA value is varying. In response to the electronic device being static or the AOA value being varying, the processor is configured to increase a value of the first connection interval.

In some examples, the one or more metrics includes a Received Signal Strength Indicator (RSSI) value and an Angle of Arrival (AOA) value and the first connection parameter includes a first connection interval. To adjust the first connection parameter, the processor is configured to compare the RSSI value with a threshold. In response to the RSSI value being greater than or equal to the threshold, the processor is configured to determine whether the electronic device is non-static and determine whether the AOA value is substantially constant. In response to the electronic device being non-static and the AOA value being substantially constant, the processor is configured to decrease a value of the first connection interval.

Some aspects relate to a method. The method includes measuring, by an electronic device, one or more metrics and determining, by the electronic device and using the one or more metrics, a first connection interval associated with a first connection to a first electronic device. The method further includes determining, by the electronic device and using the one or more metrics, a second connection interval associated with a second connection to a second electronic device. The method also includes operating, by the electronic device, the first connection based on a short range communication protocol and using the first connection interval and operating, by the electronic device, the second connection based on the short range communication protocol and using the second connection interval.

Some aspects relate to a non-transitory computer-readable medium storing instructions. When the instructions are executed by a processor of a electronic device, the instructions cause the processor to perform operations including measuring one or more metrics and determining, using the one or more metrics, a first connection interval associated with a first connection to a first electronic device. The operations further include determining, using the one or more metrics, a second connection interval associated with a second connection to a second electronic device. The operations also include operating the first connection based on a short range communication protocol and using the first connection interval and operating the second connection based on the short range communication protocol and using the second connection interval.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1A illustrates an example system implementing a mechanism for dynamically determining connection parameters of multiple connections, according to some aspects of the disclosure.

FIG. 1B illustrates two example connections with connection parameters dynamically determined, according to some aspects of the disclosure.

FIG. 2 illustrates a block diagram of an example wireless system of an electronic device implementing the mechanism for dynamically determining or adjusting connection parameters of multiple connections, according to some aspects of the disclosure.

FIG. 3 illustrates an example method for an electronic device to implement the mechanism for dynamically determining or adjusting connection parameters and/or connection priorities of multiple connections, according to some aspects of the disclosure.

FIG. 4 illustrates a diagram for one exemplary method for measuring or determining Received Signal Strength Indicator (RSSI) value for one or more connection events, according to some aspects of the disclosure.

FIG. 5 illustrates an example method 500 for an electronic device to dynamically determine or adjust connection parameters of multiple connections, according to some aspects of the disclosure.

FIG. 6 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure include apparatuses and methods for dynamically determining connection parameters (such as, but not limited to, connection interval) of multiple Bluetooth™ connections between a first electronic device and a plurality of electronic devices. It is noted that although some examples of this disclosure are discussed with respect to a Bluetooth™ protocol, a Bluetooth™ Low Energy protocol, or a Bluetooth™ Low Energy Long Range protocol, the aspects of this disclosure can be applied to any short range communication protocol and/or other communication protocols.

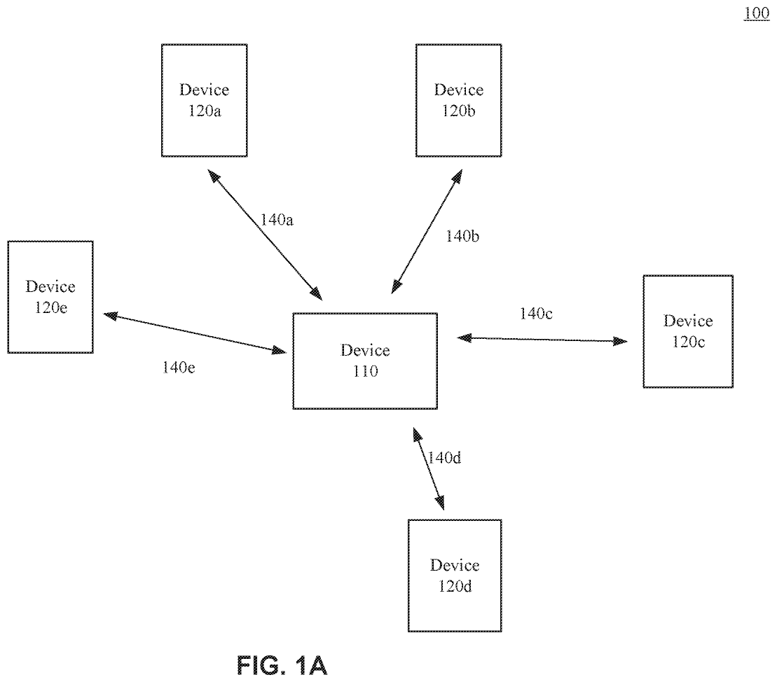

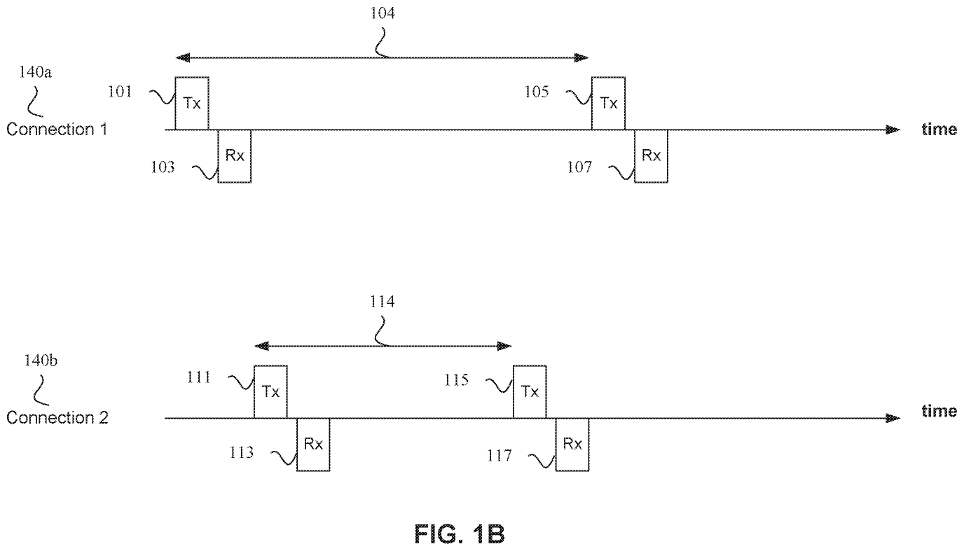

FIG. 1A illustrates an example system 100 implementing a mechanism for dynamically determining connection parameters of multiple connections, according to some aspects of the disclosure. Example system 100 is provided for the purpose of illustration only and does not limit the disclosed aspects. System 100 may include, but it not limited to, a plurality of devices 120a-120e (also collectively referred to herein as device 120 or a plurality of devices 120) and a device 110. The plurality of devices 120a-120e and device 110 may include, but are not limited to, wireless communication devices, smart phones, laptops, desktops, tablets, personal assistants, monitors, multimedia devices (e.g., televisions), human interface devices, speaker devices, headphone devices, wearable devices, medical sensors (e.g., glucose monitor, hear rate monitor, etc.), gaming devices, vehicle multimedia centers, and the like.

The connections 140a-140e are illustrated in FIG. 1A as possible connections between the plurality of devices 120a-120e and device 110. Additionally, or alternatively, based on the disclosure herein, a person of ordinary skill in art will understand that each of the plurality of devices 120a-120e can form one or more connections with other devices 120a-120e. As one example, device 120a can form a connection (not shown in FIG. 1A) with other devices 120b-120e. One or all of the connections 140a-140e (and other connections between other devices 120a-120e) may be wireless and may include, but are not limited to, a cellular network connection (such as, but not limited to, Universal Mobile Telecommunications System (UMTS), the Long-Term Evolution (LTE), connection based on 3G/4G/5G networks), a wireless local network connection (such as but not limited to Institute of Electrical and Electronics Engineers (IEEE) 802.11 standard, which is sometimes referred to as Wi-Fi), or based on Bluetooth™ protocol, Bluetooth™ Low Energy protocol, or a Bluetooth™ Low Energy Long Range protocol (from the Bluetooth Special Interest Group of Kirkland, Wash.), or any other wireless connections using standardized and/or proprietary protocols. In some aspects, one, multiple, or all of connections 140a-140e may be implemented as wired connections between each of the respective devices.

According to some aspects, the plurality of devices 120a-120e have established connections 140a-140e with device 110. In some examples, connections 140a-140e are based on Bluetooth™ protocol, Bluetooth™ Low Energy protocol, or a Bluetooth™ Low Energy Long Range protocol. According to some aspects, the plurality of devices 120a-120e share resources for their connections with device 110. In one example, the shared resource can include a Bluetooth™ transceiver of device 110. Additionally, or alternatively, the shared resource can include a communication channel. In a non-limiting example, the shared communication channel can include a 2.4 GHz wireless communication channel, a 5 GHz wireless communication channel, a 6 GHz wireless communication channel, or the like.

According to some aspects, device 110 can be configured to dynamically determine and/or adjust one or more parameters for one or more of connections 140a-140e. In some examples and considering connection 140a as an example connection, device 110 can determine and/or adjust one or more parameters for connection 140a based on one or more metrics. For example, device 110 can measure and/or determine the one or more metrics to determine and/or adjust the one or more parameters for connection 140a. In some aspects, the one or more metrics can include one or more metrics associated with connection 140a. Additionally, or alternatively, the one or more metrics can include one or more metrics associated with one or more of connections 140b-140e. Additionally, or alternatively, the one or more metrics can include one or more metrics associated with device 110. The one or more metrics can also include one or more metrics associated with one or more of devices 120a-120e.

According to some aspects, the one or more metrics associated with, for example, connection 140a can include, but is not limited to, Received Signal Strength Indicator (RSSI) value(s). In some examples, the RSSI value(s) can include a statistical value for the RSSI value(s) such as, but not limited to, maximum RSSI, minimum RSSI, mean RSSI, or the like. Additionally, or alternatively, the one or more metrics associated with connection 140a can include, but is not limited to, a motion parameter indicating at least one of the motion of device 120a, the motion of device 110, or the relative motion of device 120a relative to device 110. In one example, the motion parameter can indicate whether device 120a is moving. In another example, the motion parameter can indicate whether device 110 is moving. In another example, the motion parameter can indicate whether device 110 and device 120a are moving relative to each other. In some examples, the motion parameter can also include the velocity or other parameters associated with the motion of device 110 and/or device 120a.

According to some aspects, the one or more metrics associated with, for example, connection 140a can include an angle of arrival (AOA) value. For example, the AOA value can indicate whether and how device 120a and device 110 are moving with respect to each other. For example, the AOA value can indicate whether device 120a and device 110 are moving toward each other or moving away from each other. In another example, the AOA value can indicate that, for example, device 110 is not moving in the direction of device 120a.

It is noted that although RSSI value, motion parameter, and AOA value are discussed with respect to connection 140a, device 110 can measure and/or determine one or more of these values for one or more of other connections 140b-140e.

In addition to, or alternative to, the one or more metrics associated with, for example, connection 140a, device 110 can measure or determine one or more metrics associated with device 110. The one or more metrics associated with device 110 can include a number of digital keys available to device 110. In some examples, the digital keys can indicate a number of devices 120a-120e connected to device 110. In some examples, the digital keys can indicate a number of devices that can be connected to device 110. In some examples, the digital keys can indicate a number of devices that are associated with device 110. In a non-limiting example, the digital key can include digital car key (DCK).

According to some aspects, the one or more metrics associated with device 110 can include a battery level of device 110. According to some aspects, the one or more metrics associated with device 110 can include existing applications (e.g., user application) or use-cases that are using device 110 and/or connections 140a-140b. For example, the one or more metrics associated with device 110 can include the priority of these existing applications or user-cases. Additionally, or alternatively, the one or more metrics associated with device 110 can include current usage (e.g., bandwidth usage, power usage, etc.) of these existing applications or user-cases.

It is noted that the aspects of this disclosure are not limited to these exemplary one or more metrics associated with device 110, and device 110 can measure and/or determine other metrics associated with device 110.

In addition to, or alternative to, the one or more metrics associated with, for example, connection 140a and the one or more metrics associated with device 110, device 110 can measure or determine one or more metrics associated with one or more devices 120a-120e. In some examples, the one or more metrics associated with one or more devices 120a-120e can include battery level(s) of one or more devices 120a-120e.

Using the measured or determined one or more metrics, device 110 is configured to dynamically determine and/or adjust one or more parameters for one or more of connections 140a-140e. Additionally, or alternatively, using the measured or determined one or more metrics, device 110 can also dynamically determine and/or adjust priorities of one or more of connections 140a-140e. In some examples, the priorities of one or more connections 140a-140e can indicate which connections (within connections 140a-140e) have higher priorities and which connections (within connections 140a-140e) have lower priorities. In some examples, dynamically determining and/or adjusting one or more parameters for one or more of connections 140a-140e can be done based on the measured or determined one or more metrics and/or based on the determined priorities.

In other words, the one or more parameters and/or the priority for, for example, connection 140a can be determined based at least one on one or more metrics associated with connection 140a, one or more metrics associated with device 120a, and/or one or more metrics associated with device 110. Additionally, or alternatively, the one or more parameters and/or the priority for, for example, connection 140a can be determined in view of the other connections (e.g., one or more of connections 140b-140e). In other words, device 110 can determine the one or more parameters and/or the priority for, for example, connection 140a considering measured or determined one or more metrics for other connections (e.g., one or more of connections 140b-140e) and/or determine priorities of other connections (e.g., one or more of connections 140b-140e).

According to some aspects, the one or more parameters associated with a connection (e.g., connection 140a) can include a connection interval, as discussed in more detail below. It is noted that although some examples are provided for one or metrics (used to determine one or more connection parameters and/or connection priority), the aspects of this disclosure are not limited to these examples. Also, although some examples are provided for one or more connection parameters, the aspects of this disclosure are not limited to these examples.

As discussed above, device 110 can dynamically determine or adjust the one or more connection parameters and/or connection priorities. According to some aspects, device 110 can dynamically determine or adjust the one or more connection parameters and/or connection priorities in response to one or more conditions. In a non-limiting example, device 110 can determine or adjust the one or more connection parameters and/or connection priorities at predetermined time periods. In some examples, the predetermined time periods can be fixed time periods. In some examples, the predetermined time periods can be variable time periods.

In some examples, device 110 can determine or adjust the one or more connection parameters and/or connection priorities if a new connection is established. For example, when a new devices connects to device 110, device 110 can determine or adjust the one or more connection parameters and/or connection priorities for one or more of previous connections and/or the new connection.

In some examples, device 110 can determine or adjust the one or more connection parameters and/or connection priorities if a connection is dropped. For example, when one or more of connections 140a-104e drops, device 110 can determine or adjust the one or more connection parameters and/or connection priorities for one or more of remaining connections.

In some examples, device 110 can determine or adjust the one or more connection parameters and/or connection priorities if existing applications (e.g., user application) or use-cases that are using device 110 and/or connections 140a-140b change. For example, device 110 can determine or adjust the one or more connection parameters and/or connection priorities if the priority of these existing applications or user-cases changes. Additionally, or alternatively, device 110 can determine or adjust the one or more connection parameters and/or connection priorities if current usage (e.g., bandwidth usage, power usage, etc.) of these existing applications or user-cases changes. For example, if device 110 is using voice call or Advanced Audio Distribution Profile (A2DP) connection and device 110 ends the voice call or the A2DP connection, device 110 can determine or adjust the one or more connection parameters and/or connection priorities. In a non-limiting example, if device 110 is using voice call or a A2DP connection, device 110 can prevent any increase in default connection parameter(s) (e.g., default connection interval) of other connections.

In some examples, device 110 can determine or adjust the one or more connection parameters and/or connection priorities if one or more metrics (and/or priority) discussed above changes.

FIG. 1B illustrates two example connections with connection parameters dynamically determined, according to some aspects of the disclosure. In some examples, connection 140a can include connection between device 120a and device 110. Connection 140b can include connection between device 120b and device 110.

According to some aspects, each one of connections 140a and 140b can have one or more connection parameters and/or connection priorities determined based at least on one or more metrics, as discussed above. For example, device 110 can measure and/or determine the one or more metrics to dynamically determine and/or adjust the one or more parameters and/or priorities for connections 140a and 140b. In some aspects, the one or more metrics can include one or more metrics associated with connection 140a and/or connection 140b. Additionally, or alternatively, the one or more metrics can include one or more metrics associated with one or more of connections 140c-140e. Additionally, or alternatively, the one or more metrics can include one or more metrics associated with device 110. The one or more metrics can also include one or more metrics associated with one or more of devices 120a-120e.

As illustrated in FIG. 1B, the one or more connection parameters for connection 140a can include connection interval 104. In some examples, connection interval 104 can include transmission period 101 and reception period 103. For example, device 110 can use transmission period 101 to send data and/or other information (e.g., Bluetooth™ packets) to device 120a. In this examples, device 110 can use reception period 103 to receive data and/or other information (e.g., Bluetooth™ packets) from device 120a. In some examples, transmission period 101 and reception period 103 can be considered one connection event (CE). In this example, a second connection interval can include transmission period 105 and reception period 107. In other words, connection interval 104 can be the time interval between two consecutive CEs. In some examples, each connection interval includes one CE.

In addition to connection interval 104, the one or more connection parameters for connection 140a can include duration of transmission periods and/or duration of reception periods. However, the aspects of this disclosure are not limited to these examples and the one or more connection parameters for connection 140a can include other parameters.

As illustrated in FIG. 1B, the one or more connection parameters for connection 140b can include connection interval 114. In some examples, connection interval 114 can include transmission period 111 and reception period 113. For example, device 110 can use transmission period 111 to send data and/or other information (e.g., Bluetooth™ packets) to device 120b. In some examples, transmission period 111 and reception period 113 can be considered one connection event (CE). In this examples, device 110 can use reception period 113 to receive data and/or other information (e.g., Bluetooth™ packets) from device 120b. In this example, a second connection interval can include transmission period 115 and reception period 117. In other words, connection interval 114 can be the time interval between two consecutive CEs. In some examples, each connection interval includes one CE.

In addition to connection interval 114, the one or more connection parameters for connection 140b can include duration of transmission periods and/or duration of reception periods. However, the aspects of this disclosure are not limited to these examples and the one or more connection parameters for connection 140b can include other parameters.

According to some embodiments, device 110 can use its transceiver (e.g., Bluetooth™ transceiver) for both connections 140a and 140b. Additionally, or alternatively, connections 140a and 140b share the same communication channel (e.g., a 2.4 GHz wireless communication channel).

As illustrated in FIG. 1B, connection interval 104 of connection 140a is larger than connection interval 114 of connection 140b. In one example, connection interval 104 is larger than connection interval 114 because connection 140a has less priority than connection 140b. Additionally, or alternatively, connection interval 104 is larger than connection interval 114 because of the one or more metrics used by device 110 to determine connection intervals 104 and 114.

According to some aspects, device 110 can detect devices' clock drift (e.g., measured in parts per million (ppm) indicating how much a device's clock can drift). For example, device 110 can measure and/or detect clock drift(s) of devices 120a and 120b effectively and efficiently. If not resolved, clock drifts can affect one or more of connection intervals 104 or 114, which can result in different devices' transmission and reception periods overlap with each other, affecting the connections. By early detection of the clock drift(s), device 110 can synchronize or re-synchronize with devices 120a and 120b such that the clock drift(s) do not affect, for example, connection intervals 104 or 114. Therefore, different devices' transmission and reception periods can be separate from each other, not affecting connections 140a and 140b.

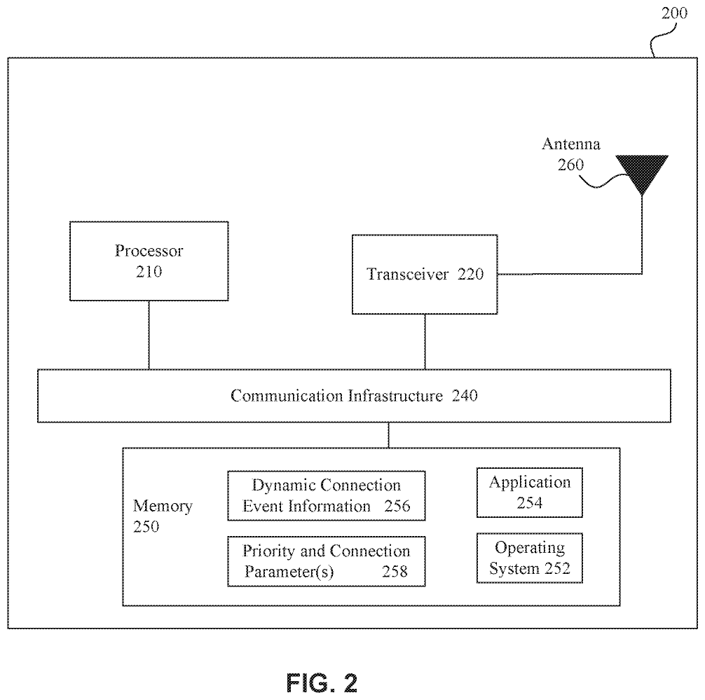

FIG. 2 illustrates a block diagram of an example wireless system 200 of an electronic device implementing the mechanism for dynamically determining or adjusting connection parameters of multiple connections, according to some aspects of the disclosure. System 200 may be any of the electronic devices (e.g., devices 110 and 120) of system 100. System 200 includes processor 210, one or more transceivers (e.g., transceiver 220), communication infrastructure 240, memory 250, operating system 252, application 254, dynamic connection even (CE) information 256, priority and connection parameters 258, and antenna 260. Illustrated systems are provided as exemplary parts of wireless system 200, and system 200 can include other circuit(s) and subsystem(s). Also, although the systems of wireless system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or transceiver 220. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, Siri™, FaceTime™, radio streaming, video streaming, remote control, gaming application(s), health applications, one or more applications associated with a vehicle, and/or other user applications.

According to some aspects, memory 250 can also store dynamic connection event (CE) information 256. In some examples, dynamic CE information 256 can include one or more metrics measured and/or determined by system 200 as discussed above. For example, dynamic CE information 256 can include one or more metrics associated with one or more connections, one or more metrics associated with system 200, and/or one or more metrics associated with one or more other devices. In some examples, system 200 can dynamically measure and adjust dynamic CE information 256 as discussed above. In a non-limiting example, dynamic CE information 256 is stored in system 200 in memory 250. In a non-limiting example, dynamic CE information 256 can be stored externally in a dynamic CE information database. In this example, system 200 can access the dynamic CE information database directly and/or through a communication network (not shown). In a non-limiting example, dynamic CE information 256 can be stored partially or completely in system 200 and/or partially or completely in the dynamic CE information database.

According to some aspects, memory 250 can also store priority and connection parameter(s) 258. In some examples, priority and connection parameter(s) 258 can include connection priorities determined or measured, as discussed above. Additionally, or alternatively, priority and connection parameter(s) 258 can include one or more connection parameters determined or measured by system 200 and as discussed above. In some examples, system 200 can dynamically determine or adjust the connection priorities and/or the one or more connection parameters in priority and connection parameter(s) 258. In a non-limiting example, priority and connection parameter(s) 258 is stored in system 200 in memory 250. In a non-limiting example, priority and connection parameter(s) 258 can be stored externally in a priority and connection parameter(s) database. In this example, system 200 can access the priority and connection parameter(s) database directly and/or through a communication network (not shown). In a non-limiting example, priority and connection parameter(s) 258 can be stored partially or completely in system 200 and/or partially or completely in the priority and connection parameter(s) database.

System 200 can also include communication infrastructure 240. Communication infrastructure 240 provides communication between, for example, processor 210, transceiver 220, and memory 250. In some implementations, communication infrastructure 240 may be a bus. Processor 210 together with instructions stored in memory 250 performs operations enabling wireless system 200 to implement the mechanism for dynamically determining or adjusting connection parameters of multiple connections as described herein. Additionally, or alternatively, transceiver 220 performs operations enabling wireless system 200 to implement the mechanism for dynamically determining or adjusting connection parameters of multiple connections as described herein.

Transceiver 220 transmit and receive communications signals that support the mechanism for dynamically determining or adjusting connection parameters of multiple connections, according to some aspects, and may be coupled to antenna 260. (Herein, transceivers can also be referred to as radios). Antenna 260 may include one or more antennas that may be the same or different types. Transceiver 220 allow system 200 to communicate with other devices that may be wired and/or wireless. In some examples, transceiver 220 can include processors, controllers, radios, sockets, plugs, buffers, and like circuits/devices used for connecting to and communication on networks. According to some examples, transceivers 220 includes one or more circuits to connect to and communicate on wired and/or wireless networks.

According to some aspects of this disclosure, transceiver 220 can include a cellular subsystem, a WLAN subsystem, and/or a Bluetooth™ subsystem, each including its own radio transceiver and protocol(s) as will be understood by those skilled arts based on the discussion provided herein. In some implementations, transceiver 220 can include more or fewer systems for communicating with other devices.

In some examples, transceiver 220 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. Additionally, or alternatively, transceiver 220 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. Additionally, transceiver 220 can include one or more circuits (including a WLAN transceiver) to enable connection(s) and communication over WLAN networks such as, but not limited to, networks based on standards described in IEEE 802.11.

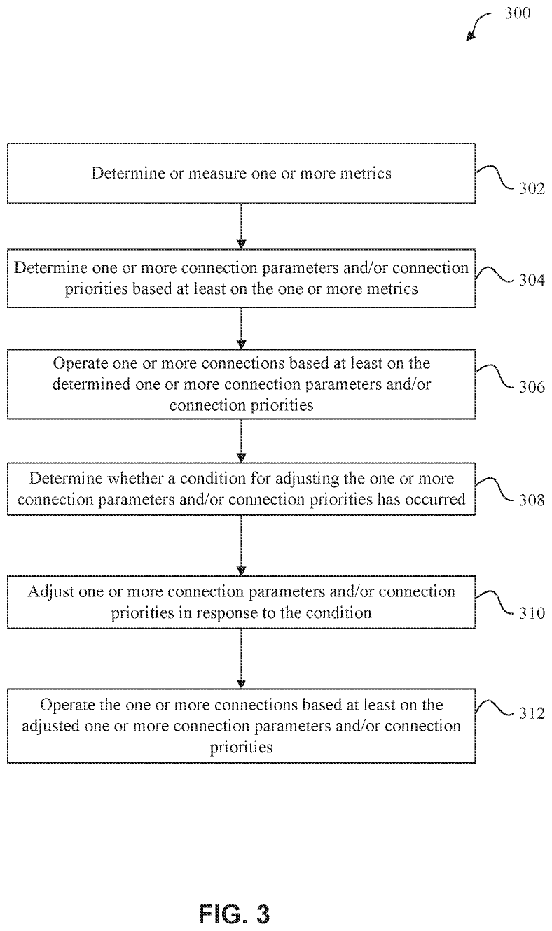

According to some aspects of this disclosure, processor 210, alone or in combination with computer instructions stored within memory 250, and/or transceiver 220 implements the mechanism for dynamically determining or adjusting connection parameters of multiple connections as discussed herein. As discussed in more detail below with respect to FIGS. 3-5, processor 210 can implement the mechanism for dynamically determining or adjusting connection parameters of multiple connections of FIGS. 1A, 1B, and 2.

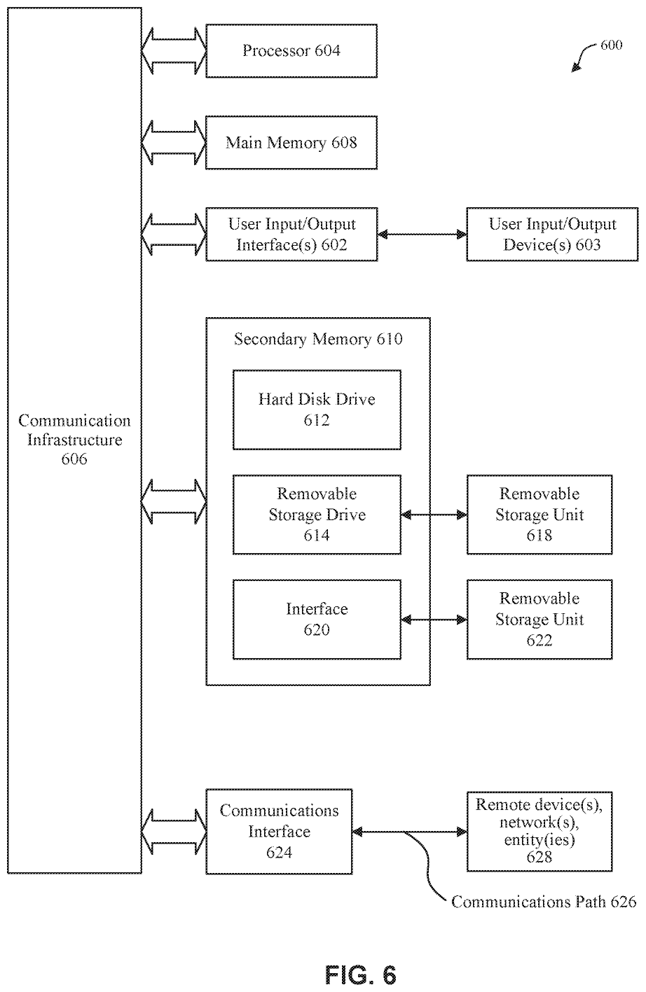

FIG. 3 illustrates an example method 300 for an electronic device to implement the mechanism for dynamically determining or adjusting connection parameters and/or connection priorities of multiple connections, according to some aspects of the disclosure. As a convenience and not a limitation, FIG. 3 may be described with regard to elements of FIGS. 1-2. Method 300 may represent the operation of an electronic device (e.g., device 110 of FIG. 1A as discussed in this disclosure) implementing a mechanism for dynamically determining or adjusting connection parameters and/or connection priorities of multiple connections. Method 300 may also be performed by system 200 of FIG. 2 and/or computer system 600 of FIG. 6. But method 300 is not limited to the specific aspects depicted in those figures and other systems may be used to perform the method as will be understood by those skilled in the art. It is to be appreciated that not all operations may be needed, and the operations may not be performed in the same order as shown in FIG. 3.

At 302, one or more metrics are measured or determined. For example, device 100 can measure or determine the one or more metrics. According to some aspects, the one or more metrics can include one or more metrics associated with one or more connections that device 110 has with one or more other devices. Additionally, or alternatively, the one or more metrics can include one or more metrics associated with device 110. Additionally, or alternatively, the one or more metrics can include one or more metrics associated with the one or more other devices that are connected to (or are going to connect to) device 110. As discussed above, the one or more metrics can include RSSI value(s), statistical value(s) associated with RSSI value(s), motion parameter(s), AOA value(s), battery level(s), battery size(s), and the like.

At 304, one or more connection parameters and/or one or more connection priorities are determined based at least on the one or more metrics. For example, device 110 can determine the one or more connection parameters and/or the one or more connection priorities. In some examples, device 110 can determine the one or more connection parameters and/or the one or more connection priorities for each one of the connections device 110 has with other devices.

At 306, the one or more connections can be operated based on the one or more connection parameters and/or the one or more connection priorities. In a non-limiting example, the connection parameter can include a connection interval. Device 110 can determine the connection interval for each of connections 140a-140e of FIG. 1A and device 110 can communicate with devices 120a-120e of FIG. 1A using the determined connection intervals.

At 308, it is determined whether one or more conditions (e.g., adjusting condition(s)) for adjusting the one or more connection parameters and/or the connection priorities has occurred. For example, device 110 determines whether the one or more conditions has occurred. In a non-limiting example, the one or more conditions can include predetermined time periods. In some examples, the predetermined time periods can be fixed time periods. In some examples, the predetermined time periods can be variable time periods. In some examples, the one or more conditions can include establishing a new connection. In some examples, the one or more conditions can include dropping a connection. In some examples, the one or more conditions can include can include changes in one or more metrics (and/or priorities) discussed above.

At 310, the one or more connection parameters and/or the connection priorities are adjusted if the condition is met (e.g., the adjusting condition(s) has occurred). For example, device 110 can adjust the one or more connection parameters and/or the connection priorities when it detects that the one or more conditions are met. According to some aspects, to adjust the one or more connection parameters and/or the connection priorities, device 110 can measure or determine the one or more metrics (e.g., updated metric(s) and/or new metric(s)) as discussed in 302.

At 312, the adjusted one or more connection parameters and/or the adjusted connection priorities can be used to operate the one or more connections. In a non-limiting example, the updated connection parameter can include an updated connection interval. Device 110 can determine the updated connection interval for one or more of connections 140a-140e of FIG. 1A and device 110 can communicate with the respective device in the plurality of devices 120a-120e of FIG. 1A using the updated connection interval. Method 300 can be repeated by going back to step 302 and/or 312.

Some examples of the mechanism for dynamically determining or adjusting connection parameters and/or connection priorities of multiple connections are discuss below with respect to a smart phone and a vehicle. For example, device 110 of FIG. 1A can include a smart phone implementing the mechanism for dynamically determining or adjusting connection parameters and/or connection priorities of multiple connections including connection 140a with a vehicle (e.g., a multimedia center) 120a. It is noted that the use of a smart phone and a vehicle are provided for the purpose of illustration only and does not limit the disclosed aspects. The aspects of this disclosure can be applied to any devices as discussed herein.

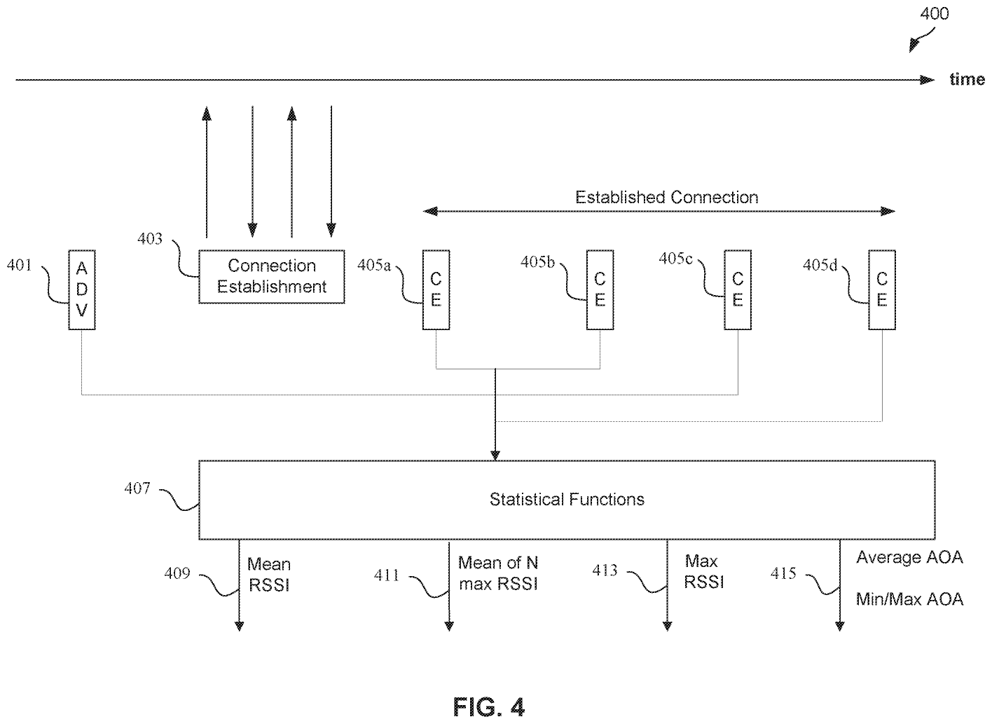

FIG. 4 illustrates a diagram 400 for one exemplary method for measuring or determining RSSI value(s) for one or more connection events, according to some aspects of the disclosure. In some examples, diagram 400 of FIG. 4 can include an RSSI ranging operation as, for example, phase 1 of a mechanism for dynamically determining or adjusting connection parameters and/or connection priorities of multiple connections. According to some aspects, FIG. 4 is one example of a method to perform step 302 of FIG. 3.

According to some aspects, the method of FIG. 4 can be performed by device 110 of FIG. 1A for measuring or determining one or more metrics associated with, for example, connection 140a with device 120a. For example, the method of FIG. 4 can be performed by one or more of transceiver 220 or processor 210 of FIG. 2 in connection with memory 250. In this example, the one or more metrics can include RSSI values and/or statistical values of the RSSI values.

According to some aspects, the method of FIG. 4 can include an advertising event 401. During advertising event 401, device 110 (e.g., a smart phone) can receive one or more advertising messages (e.g., one or more advertising packets) from device 120a (e.g., a vehicle). In some examples, device 110 can receive the advertising messages during one or more scan windows of device 110. In some examples, device 120a can use the advertising messages and device 110 can use scanning as part of a discovery process such that device 110 would discover device 120a, and devices 110 and 120a can establish a connection at connection establishment event 403.

After connection establishment event 403, devices 110 and 120a can communicate with each other using the established connection. The communication between devices 110 and 120a can include communicating data or other information. According to some aspects, the communication between devices 110 and 120a can include one or more connection events 405a-405d (also collectively referred to herein as connection event (CE) 405). In some examples, each CE 405 can include one or more transmission periods and/or one or more reception period as discussed, for example, with respect to FIG. 1B. In some examples, CEs 405 are separated from each other in time as much as a connection interval determined by, for example, device 110.

According to some examples, device 110 is configured to estimate the condition of the connection (e.g., the link) between device 110 and device 120a (e.g., connection 140a). In some examples, device 110 can estimate the condition of the connection (e.g., the link) to device 120a based on the message(s) device 110 receives from device 120a. Additionally, or alternatively, device 110 can estimate the condition of the connection to device 120a based on information device 110 receives from device 120a and/or other devices connected to device 110. In some examples, device 110 can estimate the condition of the connection to device 120a at least at advertising event 401 and/or at one or more of CEs 405. For example, device 110 can estimate the condition of the connection to device 120a at each of CEs 405. For example, device 110 can estimate the condition of the connection to device 120a for every connection interval. In a non-limiting examples, device 110 can estimate the condition of the connection to device 120a at advertising even 401 after an automatic gain control (AGC) has settled. However, the aspects of this disclosure are not limited to these examples, and device 110 can estimate the condition of the connection (e.g., the link) to device 120a at other time instants.

According to some aspects, to estimate the condition of the connection (e.g., the link) to device 120a, device 110 can measure the RSSI value(s) associated with the connection. For example, device 110 can measure the RSSI value(s) associated with the connection for each one of CEs 405. According to some aspects, to estimate the condition of the connection (e.g., the link) to device 120a, device 110 can measure the AOA value(s) associated with the connection. For example, device 110 can measure the AOA value(s) associated with the connection for each one of CEs 405. However, the aspects of this disclosure are not limited to these examples, and device 110 can estimate the condition of the connection (e.g., the link) to device 120a using other metrics.

According to some aspects, once device 110 measures and/or estimates the condition of the connection to device 120a, device 110 can store the measured and/or estimated value(s) (e.g., measured RSSI value(s), measured AOA value(s), or the like) in a database. For example, device 110 can store the estimated value(s) in dynamic CE information database 256 stored in memory 250 of FIG. 2. According to some aspects, the estimated value(s) are associated with device 120a and/or connection 140a are stored in the database accordingly. In other words, the database (e.g., dynamic CE information 256 of FIG. 2) can include estimated value(s) associated with each device (and/or each connection) that is (or was) connected to device 110, according to some examples. Therefore, device 110 can use the stored estimated value(s) in its operations including, but not limited to, determining or adjusting connection parameter(s) and/or connection priorities.

In addition to, or in alternate to, the RSSI value(s), the estimated values can include statistical values for the RSSI value(s) such as, but not limited to, maximum RSSI, minimum RSSI, mean RSSI, or the like. For examples, the measured RSSI values from, for example, one or more of advertising event 401, CEs 405, or the like can be input to statistical functions 407 to generate statistical values 409, 411, and/or 413. In a non-limiting example, statistical functions 407 can generate mean RSSI 409 based on one or more input RSSI values. In a non-limiting example, statistical functions 407 can generate mean of N maximum RSSI 411 based on one or more input RSSI values, where N is an integer number. In one example, mean of N maximum RSSI 411 can include the mean of one or more maximum RSSI values. The one or more maximum RSSI values can be generated based on a plurality of RSSI values. In a non-limiting example, statistical functions 407 can generate maximum RSSI 413 based on one or more input RSSI values. In some examples, statistical functions 407 can generate statistical values 409, 411, and/or 413 using a moving window with a window size of N being an integer. However, the aspects of this disclosure can also use other functions to determine statistical values 409, 411, and/or 413. In some examples, the statistical functions 407 can be performed in device 110 while device 110 is in a sleep mode.

According to some aspects, once device 110 determines statistical values 409, 411, and/or 413, device 110 can store statistical values 409, 411, and/or 413 in a database. For example, device 110 can store statistical values 409, 411, and/or 413 in dynamic CE information database 256 of FIG. 2.

In addition to, or in alternate to, the AOA value(s), the estimated values can include statistical values for the AOA value(s) such as, but not limited to, maximum AOA, minimum AOA, average AOA, or the like. For examples, the measured AOA values from, for example, one or more of advertising event 401, CEs 405, or the like can be input to statistical functions 407 to generate statistical values 415. In a non-limiting example, statistical functions 407 can generate statistical values 415 based on one or more input AOA values. In some examples, statistical functions 407 can generate statistical values 415 using a moving window with a window size of N being an integer. However, the aspects of this disclosure can also use other functions to determine statistical values 415. In some examples, the statistical functions 407 can be performed in device 110 while device 110 is in a sleep mode. According to some aspects, once device 110 determines statistical values 415, device 110 can store statistical values 415 in a database. For example, device 110 can store statistical values 415 in dynamic CE information 256 of FIG. 2.

Although FIG. 4 was discussed with respect to RSSI values and AOA values, the aspects of this disclosure are not limited to these metrics, and FIG. 4 and/or other aspects of this disclosure can be used to determine and/or measures more metrics and/or other metrics associated with one or more connections and/or one or more devices.

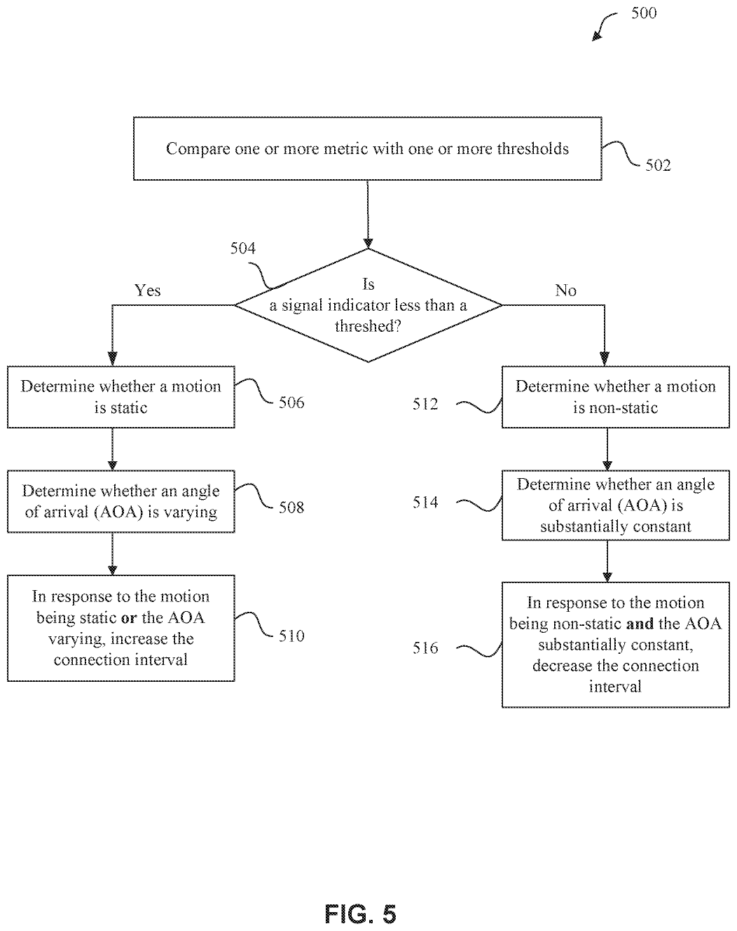

FIG. 5 illustrates an example method 500 for an electronic device to dynamically determine or adjust connection parameters of multiple connections, according to some aspects of the disclosure. As a convenience and not a limitation, FIG. 5 may be described with regard to elements of FIGS. 1-4. Method 500 may represent the operation of an electronic device (e.g., device 110 of FIG. 1A as discussed in this disclosure) implementing a mechanism for dynamically determining or adjusting connection parameters of multiple connections. Method 500 may also be performed by system 200 of FIG. 2 and/or computer system 600 of FIG. 6. But method 500 is not limited to the specific aspects depicted in those figures and other systems may be used to perform the method as will be understood by those skilled in the art. It is to be appreciated that not all operations may be needed, and the operations may not be performed in the same order as shown in FIG. 5. According to some aspects, method 500 can be one example of step 304 of FIG. 3.

Although FIG. 5 is discussed with respect to RSSI values, AOA values, and motion parameter, the aspects of this disclosure are not limited to these metrics, and FIG. 5 and/or other aspects of this disclosure can be used to use more metrics, less metrics, and/or other metrics to dynamically determine or adjust connection parameters of multiple connections. In some examples, method 500 can be performed after dynamic CE information database 256 of FIG. 2 is populated using, for example, method of FIG. 4. For example, method 500 can be performed for subsequent advertising and/or CE events.

At 502, one or more metrics are compared with one or more thresholds. For example, device 110 is configured to dynamically determine or adjust connection parameters of multiple connections by comparing one or more metrics with one or more thresholds. According to some aspects, the one or more threshold can be stored in, for example, memory 250 of FIG. 2. For example, the one or more threshold can be stored in database 256. Additionally, or alternatively, the one or more threshold can be stored in an external database accessible by device 110. In one example, the one or more metrics can include RSSI value(s) and/or statistical value(s) of the RSSI value(s). According to some aspects, the RSSI value(s) and/or statistical value(s) of the RSSI value(s) can be stored in a database (e.g., dynamic CE information 256 of FIG. 2.) Additionally, or alternatively, the RSSI value(s) and/or statistical value(s) of the RSSI value(s) can be determined by device 110 as discussed above with respect to, for example, FIG. 4.

At 504, a signal indicator (e.g., a RSSI value and/or a statistical value of the RSSI value) is compared to a threshold. The threshold can be stored in memory 250 of FIG. 2 and/or other storage device(s). If the signal indicator is less than the threshold, method 500 moves to 506. At 506, it is determined whether device 110 and/or device 120a are moving. For example, device 110 can use a motion parameter to determine whether device 110 and/or device 120a are moving. For example, as discussed above, a motion parameter can indicate at least one of the motion of device 120a, the motion of device 110, or the relative motion of device 120a relative to device 110.

At 508, it is determined whether an AOA is varying. For example, device 110 can use measured AOA value(s) and/or associated statistical values to determine whether AOA is varying. In one example, varying AIA can indicate that device 110 and device 120a are not moving toward each other. For example, varying AIA can indicate that a user holding a smart phone is not moving toward a vehicle.

If it is determined that a motion is static (e.g., device 110 is not moving) or the AOA is varying (e.g., device 110 is not moving toward device 120a or vice versa), then at 510 the connection interval associated with the connection between devices 110 and 120a is increased. As discussed above, the connection interval can include connection interval 104 and/or 114 of FIG. 4 and/or time interval(s) between consecutive CEs 405a-405d of FIG. 4. In this example (e.g., a relax CE mode), the connection interval is increased because based on the determined metrics (e.g., RSSI value, motion parameter, and/or AIA value) device 110 can determine that device 110 (e.g., a smart phone) is far from device 120a (e.g., a vehicle). Therefore, device 110 can relax the connection interval. In some examples, device 110 can adjust the connection interval based on predetermined values. For example, device 110 can increase the connection interval to the next predetermined value for the connection interval. Additionally, or alternatively, device 110 can adjust the connection interval based on the determined metrics (e.g., RSSI value, motion parameter, and/or AIA value). For example, depending on the determined metrics, device 110 can adjust the connection interval such that different determined metrics can result in different adjusted connection intervals. However, the aspects of this disclosure are not limited to these examples, and device 110 can adjust the connection interval using other methods/strategies.

Going back to 504, if the signal indicator is equal to or greater than the threshold, method 500 moves to 512. At 512, it is determined whether device 110 and/or device 120a are moving. For example, device 110 can use a motion parameter to determine whether device 110 and/or device 120a are moving. For example, as discussed above, a motion parameter can indicate at least one of the motion of device 120a, the motion of device 110, or the relative motion of device 120a relative to device 110.

At 514, it is determined whether an AOA is constant or substantially constant. For example, device 110 can use AOA value(s) and/or associated statistical values to determine whether AOA is constant or substantially constant (e.g., not varying or not substantially varying). In one example, constant or substantially constant AIA can indicate that device 110 and device 120a are moving toward each other. For example, constant or substantially constant AIA can indicate that a user holding a smart phone is moving toward a vehicle.

If it is determined that a motion is non-static (e.g., device 110 and/or device 120a is/are moving) and the AOA is constant or substantially constant (e.g., device 110 is moving toward device 120a or vice versa), then at 516 the connection interval associated with the connection between devices 110 and 120a is decreased. In this example (e.g., an aggressive CE mode), the connection interval is decreased because based on the determined metrics (e.g., RSSI value, motion parameter, and/or AIA value) device 110 can determine that device 110 (e.g., a smart phone) is moving toward and getting closer to device 120a (e.g., a vehicle). Therefore, device 110 can decrease the connection interval. In some examples, device 110 can adjust the connection interval based on predetermined values. For example, device 110 can decrease the connection interval to the previous predetermined value for the connection interval. Additionally, or alternatively, device 110 can adjust the connection interval based on the determined metrics (e.g., RSSI value, motion parameter, and/or AIA value). For example, depending on the determined metrics, device 110 can adjust the connection interval such that different determined metrics can result in different adjusted connection intervals. However, the aspects of this disclosure are not limited to these examples, and device 110 can adjust the connection interval using other methods/strategies.

According to some aspects method 500 can be repeated for every connection event (CE) and/or every advertising event. Alternatively, method 500 can be repeated based on a predetermined schedule (e.g., using a predetermine time period). In another example, method 500 can be repeated based on a schedule determined by, for example, device 110. However, the aspects of this disclosure are not limited to these examples, and method 500 can be repeated based on other schedule. In a non-limiting example, for each CE (or some of the CEs), the one or more metrics (e.g., RSSI value, motion parameter, and/or AIA value) can be monitored. Depending the determined metrics, device 110 can enter a normal CE mode, the relax CE mode (e.g., 510) or the aggressive CE mode (e.g., 516). In one example, depending on the determined RSSI value and the motion of device 110, device 110 can decide to enable (or re-enable) the normal CE mode. In some examples, the normal CE mode can include a mode with a predetermined (e.g., a default) connection interval. In some examples, the relax CE mode can include a mode with larger connection interval(s) (e.g., larger compared to the predetermined (e.g., the default) connection interval). In a non-limiting example, in the relax CE mode, the connection interval can be relaxed form a first value (e.g., 30 ms) to a second value (e.g., 60 ms) larger than the first value. In some examples, the aggressive CE mode can include a mode with smaller connection interval(s) (e.g., smaller compared to the predetermined (e.g., the default) connection interval). In some examples, the aggressive CE mode can allow faster transfer of data and/or information and can reduce connection time. In a non-limiting example, if a RSSI value is at a first threshold (e.g., 95%) at a second threshold distance (e.g., 6 m) of device 110 from device 120a and/or device 110's motion is static, then device 110 can decide to enable (or re-enable) the normal CE mode. It is noted that the aspects of this disclosure are not limited to these examples, and device 110 can use other criteria to enable (or re-enable) the normal CE mode.

According to some aspects, device 110 can decide to enter the relax CE mode based on other metrics. For example, device 110 can use its battery lever to overwrite or overweight other metrics for entering the relax CE mode. For example, device 110 can compare its battery level with a threshold. In response to the battery level being less than the threshold, device 110 can overwrite or overweight other metrics for entering the relax CE mode.

By dynamically determining the connection parameters and/or connection priorities of multiple connections (e.g., short range communication protocol such as, but not limited to, Bluetooth™), resources (such as, but not limited to, connection time, power, etc.) can be shared efficiently and effectively between multiple devices. Additionally, or alternatively, user experiences can be improved by dynamically determining the connection parameters based on, for example, connection requirements and/or priorities of the connections. For example, by increasing a priority associated with a connection (e.g., for a user application or use-case), message exchange (e.g., DCK message exchange) between two devices (e.g., a smart phone and a vehicle) can be sped up to improve the user experience. Additionally, or alternatively, aspects of this disclosure can improve detection of devices' clock drift (e.g., measured in parts per million (ppm) indicating how much a device's clock can drift). For example, a device (such as device 110) connected to multiple devices (e.g., devices 120) can measure and/or detect clock drift(s) of devices 120 efficiently. By early detection of the clock drift(s), device 110 can synchronize or re-synchronize with devices 120 such that the clock drift(s) do not affect, for example, the connection intervals of devices 120.

Various aspects can be implemented, for example, using one or more computer systems, such as computer system 600 shown in FIG. 6. Computer system 600 can be any well-known computer capable of performing the functions described herein such as devices 110, 120 of FIGS. 1, 200 of FIG. 2. Computer system 600 includes one or more processors (also called central processing units, or CPUs), such as a processor 604. Processor 604 is connected to a communication infrastructure 606 (e.g., a bus.) Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “some aspects,” “an example,” “some examples” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. An electronic device, comprising:
a transceiver configured to communicate based on a short range communication protocol; and
a processor communicatively coupled to the transceiver and configured to:
measure one or more metrics;
determine, using the one or more metrics, a first connection parameter associated with a first connection to a first electronic device;
determine, using the one or more metrics, a second connection parameter associated with a second connection to a second electronic device; and
operate the first connection based on the first connection parameter and the second connection based on the second connection parameter.

2. The electronic device of claim 1, wherein the first connection parameter comprises a first connection interval associated with the first connection and the second connection parameter comprises a second connection interval associated with the second connection.

3. The electronic device of claim 1, wherein:
to determine the first connection parameter, the processor is configured to determine a first priority associated with the first connection, and
to determine the second connection parameter, the processor is configured to determine a second priority associated with the second connection.

4. The electronic device of claim 1, wherein the one or more metrics comprises at least one of a Received Signal Strength Indicator (RSSI) value, an Angle of Arrival (AOA) value, a motion parameter, or a battery level.

5. The electronic device of claim 1, wherein the processor is further configured to:
determine whether an adjusting condition has occurred; and
in response to determining that the adjusting condition has occurred, adjust at least one of the first connection parameter or the second connection parameter.

6. The electronic device of claim 5, wherein the adjusting condition comprises at least one of:
a predetermined time period,
the electronic device establishing a third connection with a third electronic device, or
the electronic device dropping the second connection with the second electronic device.

7. The electronic device of claim 5, wherein the one or more metrics comprises a Received Signal Strength Indicator (RSSI) value and an Angle of Arrival (AOA) value, wherein the first connection parameter comprises a first connection interval, and wherein to adjust the first connection parameter, the processor is configured to:
compare the RSSI value with a threshold;
in response to the RSSI value being less than the threshold:
determine whether the electronic device is static; and
determine whether the AOA value is varying; and
in response to the electronic device being static or the AOA value being varying, increase a value of the first connection interval.

8. The electronic device of claim 5, wherein the one or more metrics comprises a Received Signal Strength Indicator (RSSI) value and an Angle of Arrival (AOA) value, wherein the first connection parameter comprises a first connection interval, and wherein to adjust the first connection parameter, the processor is configured to:
compare the RSSI value with a threshold;
in response to the RSSI value being greater than or equal to the threshold:
determine whether the electronic device is non-static; and
determine whether the AOA value is substantially constant; and
in response to the electronic device being non-static and the AOA value being substantially constant, decrease a value of the first connection interval.

9. The electronic device of claim 1, wherein the first and second connections are based on the short range communication protocol.

10. A method, comprising:
measuring, by an electronic device, one or more metrics;
determining, by the electronic device and using the one or more metrics, a first connection interval associated with a first connection to a first electronic device;
determining, by the electronic device and using the one or more metrics, a second connection interval associated with a second connection to a second electronic device;
operating, by the electronic device, the first connection based on a short range communication protocol and using the first connection interval; and
operating, by the electronic device, the second connection based on the short range communication protocol and using the second connection interval.

11. The method of claim 10, wherein:
determining the first connection interval comprises determining a first priority associated with the first connection, and
determining the second connection interval comprises determining a second priority associated with the second connection.

12. The method of claim 10, wherein the one or more metrics comprises at least one of a Received Signal Strength Indicator (RSSI) value, an Angle of Arrival (AOA) value, a motion parameter, or a battery level.

13. The method of claim 10, further comprising:
determining whether an adjusting condition has occurred; and
in response to determining that the adjusting condition has occurred, adjusting at least one of the first connection interval or the second connection interval.

14. The method of claim 13, wherein the adjusting condition comprises at least one of:
a predetermined time period,
the electronic device establishing a third connection with a third electronic device, or
the electronic device dropping the second connection with the second electronic device.

15. The method of claim 13, wherein the one or more metrics comprises a Received Signal Strength Indicator (RSSI) value and an Angle of Arrival (AOA) value, and wherein the adjusting the first connection interval comprises:
comparing the RSSI value with a threshold;
in response to the RSSI value being less than the threshold:
determining whether the electronic device is static; and
determining whether the AOA value is varying; and
in response to the electronic device being static or the AOA value being varying, increasing a value of the first connection interval.

16. The method of claim 13, wherein the one or more metrics comprises a Received Signal Strength Indicator (RSSI) value and an Angle of Arrival (AOA) value, and wherein the adjusting the first connection interval comprises:
comparing the RSSI value with a threshold;
in response to the RSSI value being greater than or equal to the threshold:
determining whether the electronic device is non-static; and
determining whether the AOA value is substantially constant; and
in response to the electronic device being non-static and the AOA value being substantially constant, decreasing a value of the first connection interval.

17. A non-transitory computer-readable medium storing instructions that, when executed by a processor of an electronic device, cause the processor to perform operations, the operations comprising:
measuring one or more metrics;
determining, using the one or more metrics, a first connection interval associated with a first connection to a first electronic device;
determining, using the one or more metrics, a second connection interval associated with a second connection to a second electronic device;
operating the first connection based on a short range communication protocol and using the first connection interval; and
operating the second connection based on the short range communication protocol and using the second connection interval.

18. The computer-readable medium of claim 17, the operations further comprising:
determining whether an adjusting condition has occurred; and
in response to determining that the adjusting condition has occurred, adjusting at least one of the first connection interval or the second connection interval.

19. The computer-readable medium of claim 18, wherein the one or more metrics comprises a Received Signal Strength Indicator (RSSI) value and an Angle of Arrival (AOA) value, and wherein the adjusting the first connection interval comprises:
comparing the RSSI value with a threshold;
in response to the RSSI value being less than the threshold:
determining whether the electronic device is static; and
determining whether the AOA value is varying; and
in response to the electronic device being static or the AOA value being varying, increasing a value of the first connection interval.

20. The computer-readable medium of claim 18, wherein the one or more metrics comprises a Received Signal Strength Indicator (RSSI) value and an Angle of Arrival (AOA) value, and wherein the adjusting the first connection interval comprises:
comparing the RSSI value with a threshold;
in response to the RSSI value being greater than or equal to the threshold:
determining whether the electronic device is non-static; and
determining whether the AOA value is substantially constant; and
in response to the electronic device being non-static and the AOA value being substantially constant, decreasing a value of the first connection interval.
